(19) United States
(12) Patent Application Publication
(10) Pub. No.: US 2026/0311569 A1
(43) Pub. Date: Oct. 8, 2026

(54) CLAW MACHINE HAVING MAIN CONTROL BOARD DRIVE DEVICE

(71) Applicant: FA TENG TECHNOLOGY CO., LTD., Taichung City (TW)

(72) Inventor: Shau-Yu Lin, Taichung City (TW)

(21) Appl. No.: 19/172,677

(22) Filed: Apr. 8, 2025

(51) Int. Cl. G07F 17/32; A63F 9/30

(52) U.S. Cl. CPC G07F 17/3297; A63F 9/30; G07F 17/3209; G07F 17/3213; G07F 17/3223; G07F 17/3225; G07F 17/3272

(57) ABSTRACT

A claw machine having a main control board drive device is disclosed. The claw machine includes a plurality of claw units and a main control board. Each of the claw units is electrically connected to a driver board. The main control board is electrically coupled to the driver boards of the claw units in a one-to-many manner through a plurality of transmission core wires so that the main control board is capable of transmitting electronic signals to the driver boards of the claw units. Thus, the cost of the main control board and the driver boards can be reduced greatly and individual faulty driver boards can be replaced or repaired, achieving the practical progress of cost reduction and maintenance convenience.

### BACKGROUND OF THE PRESENT INVENTION

### Field of Invention

The present invention relates to a claw machine, and more particularly to a claw machine having a main control board drive device. The claw machine comprises a plurality of claw units and a main control board. Each of the claw units is electrically connected to a driver board. The main control board is electrically coupled to the driver boards of the claw units in a one-to-many manner through a plurality of transmission core wires so that the main control board is capable of transmitting electronic signals to the driver boards of the claw units.

### Description of Related Arts

FIG. 1 is a block diagram of a main control board and a driver board of a conventional claw machine. The conventional claw machine includes four claw units, which can be manipulated in a single-player mode or a multi-player mode. The four claw units are defined as a first claw unit A1, a second claw unit A2, a third claw unit A3, and a fourth claw unit A4, respectively. The first claw unit A1 is electrically coupled to a first control unit C1. The second claw unit A2 is electrically coupled to a second control unit C2. The third claw unit A3 is electrically coupled to a third control unit C3. The fourth claw unit A4 is electrically coupled to a fourth control unit C4. The claw machine is equipped with a first main control board B1, a second main control board B2, a third main control board B3 and a fourth main control board B4 corresponding to the respective claw units. The first main control board B1 is electrically connected to a first driver board D1. The second main control board B2 is electrically connected to a second driver board D2. The third main control board B3 is electrically connected to a third driver board D3. The fourth main control board B4 is electrically connected to a fourth driver board D4. The first main control board B1 and the first driver board D1 are electrically coupled to the first claw unit A1 through a first transmission cable L1. The second main control board B2 and the second driver board D2 are electrically coupled to the second claw unit A2 through a second transmission cable L2. The third main control board B3 and the third driver board D3 are electrically coupled to the third claw unit A3 through a third transmission cable L3. The fourth main control board B4 and the fourth driver board D4 are electrically coupled to the fourth claw unit A4 through a fourth transmission cable L4. The first main control board B1, the second main control board B2, the third main control board B3 and the fourth main control board B4 are electrically coupled to a counting receiving board N2 via conductive cables. The counting receiving board N2 is electrically connected to a coin acceptor N1. However, the four claw units of the conventional claw machine require four main control boards and four driver boards, resulting in higher costs for the main control boards and the driver boards of the entire machine. Besides, the main control boards and the driver boards of the conventional claw machine are electrically integrated, which makes it necessary to replace and repair the whole machine in case of a malfunction, thus causing inconvenience and financial burden for operators.

### SUMMARY OF THE PRESENT INVENTION

The primary object of the present invention is to solve the aforesaid problems and to provide a claw machine having a main control board drive device. In the conventional claw machine, the four claw units require four main control boards and four driver boards, so the component cost of the main control board and the driver boards of the whole machine is relatively high. Besides, the main control boards and the driver boards of the conventional claw machine are electrically integrated, which makes it necessary to replace and repair the whole machine in case of a malfunction, thus causing inconvenience and financial burden for operators.

In order to achieve the foregoing object, the present invention provides a claw machine having a main control board drive device, comprising at least two interconnected claw units and a main control board. The claw units each include a control unit. Each of the claw units is electrically connected to a driver board. The main control board is electrically coupled to the driver boards of the claw units in a one-to-many manner through a plurality of transmission core wires so that the main control board is capable of transmitting electronic signals to the driver boards of the claw units.

In the present invention, each claw unit in the claw machine is electrically connected to a driver board. The main control board is electrically coupled to the driver boards of the claw units in a one-to-many manner through multiple transmission core wires. The single main control board is capable of transmitting electronic signals to the multiple driver boards, so that the cost of the main control board and the driver boards can be reduced greatly and individual faulty driver boards can be replaced or repaired. The present invention achieves the practical progress of cost reduction and maintenance convenience.

### BRIEF DESCRIPTION OF THE DRAWINGS

FIG. 1 is a block diagram of a main control board and a driver board of a conventional claw machine;

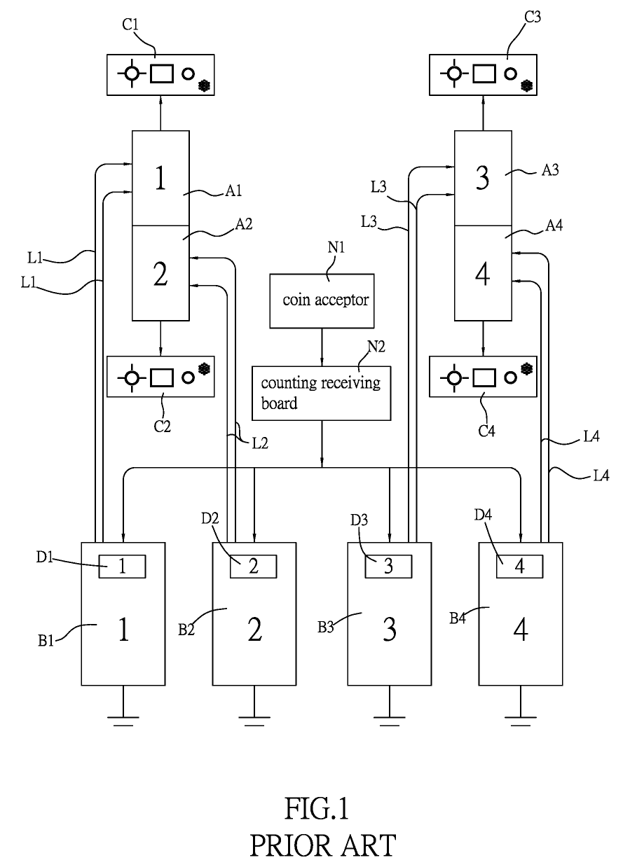

FIG. 2 is a schematic view of a main control board drive device of a claw machine of the present invention; and

FIG. 3 is a block diagram of the main control board drive device of the claw machine of the present invention.

### DETAILED DESCRIPTION OF THE PREFERRED EMBODIMENT

Embodiments of the present invention will now be described, by way of example only, with reference to the accompanying drawings.

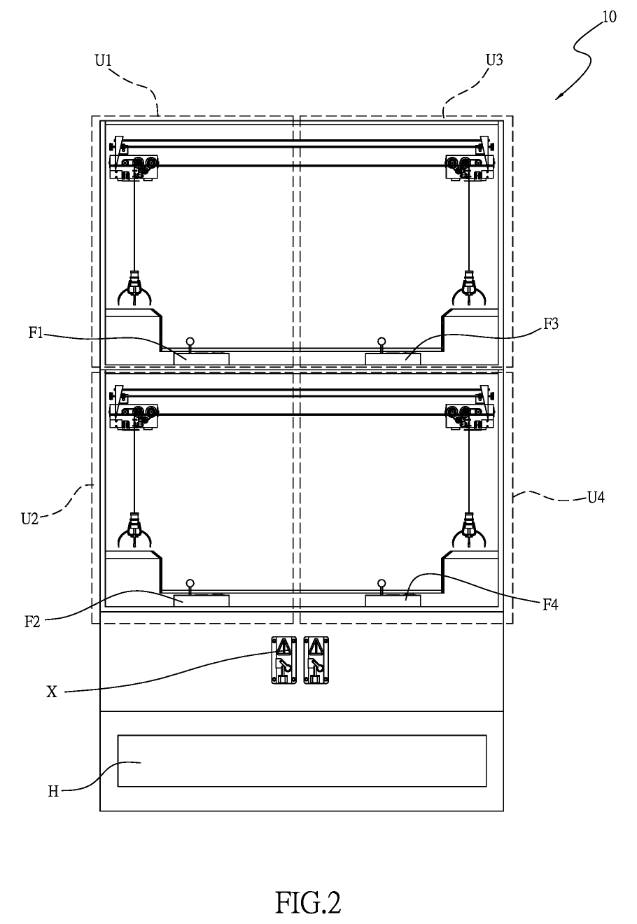

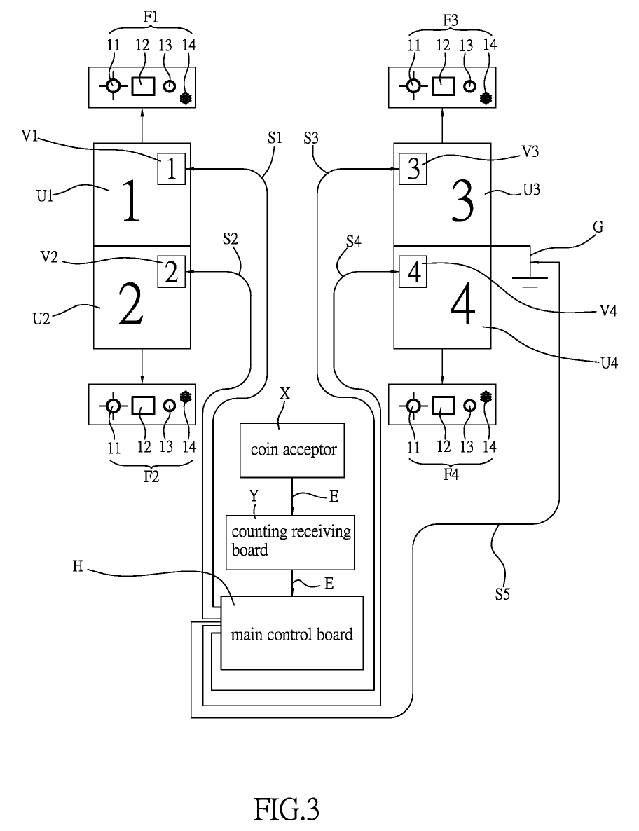

Referring to FIG. 2 and FIG. 3, the present invention discloses a claw machine having a main control board drive device.

A claw machine 10 includes a main control board H and four claw units. The four claw units are defined as a first claw unit U1, a second claw unit U2, a third claw unit U3 and a fourth claw unit U4, respectively. As shown in FIG. 2, the first claw unit U1 is located at the upper left, the second claw unit U2 is located at the lower left, the third claw unit U3 is located at the upper right, and the fourth claw unit U4 is located at the lower right.

As shown in FIG. 3, the first claw unit U1 is electrically coupled to a first driver board V1, the second claw unit U2 is electrically coupled to a second driver board V2, the third claw unit U3 is electrically coupled to a third driver board V3, and the fourth claw unit U4 is electrically coupled to a fourth driver board V4. The first driver board V1 is electrically coupled to a first control unit F1, the second driver board V2 is electrically coupled to a second control unit F2, the third driver board V3 is electrically coupled to a third control unit F3, and the fourth driver board V4 is electrically coupled to a fourth control unit F4. Any one of the aforementioned claw units is electrically connected to a ground G. The main control board H is equipped with a cable containing five core wires. The fine core wires are defined as a first transmission core wire S1, a second transmission core wire S2, a third transmission core wire S3, a fourth transmission core wire S4, and a fifth transmission core wire S5. The first transmission core wire S1 is electrically coupled to the first driver board V1. The second transmission core wire S2 is electrically coupled to the second driver board V2. The third transmission core wire S3 is electrically coupled to the third driver board V3. The fourth transmission core wire S4 is electrically coupled to the fourth driver board V4. The fifth transmission core wire S5 is electrically coupled to the ground G.

The main control board H is electrically coupled to the first driver board V1, the second driver board V2, the third driver board V3 and the fourth driver board V4 of the first claw unit U1, the second claw unit U2, the third claw unit U3 and the fourth claw unit U4 by means of the first transmission core wire S1, the second transmission core wire S2, the third transmission core wire S3, the fourth transmission core wire S4 and the fifth transmission core wire S5 in a one-to-many manner, so that the single main control board H is capable of transmitting electronic signals to the plurality of driver boards.

The main control board H is electrically coupled to a counting receiving board Y through a transmission cable E. The counting receiving board Y is electrically coupled to a coin acceptor X through another transmission cable E. The coin data is transmitted to the counting receiver board Y by means of the coin value of the coin acceptor X through the another transmission cable E. For example, if a single game is $10, a user can play 5 times by putting $50 coins into the coin acceptor X. The counting receiver board Y transmits the counting data to the main control board H via the transmission cable E. Then, the main control board H transmits the counting data to the first driver board V1 of the first claw unit U1, the second driver board V2 of the second claw unit U2, the third driver board V3 of the third claw unit U3 and the fourth driver board V4 of the fourth claw unit U4 via the transmission core wires. The driver boards of the claw units are controlled by the respective control units, so that the counting data is fed back for playing the game in a single-player mode or a multi-player mode.

The control unit electrically connected to the driver board of each claw unit includes a joystick 11, a liquid crystal display 12, a button 13, and a speaker 14. The user can select the desired claw unit, single-player mode or multi-player mode by controlling the joystick 11, looking at the liquid crystal display 12, listening to the beeps from the speaker 14, and then press the button 13 for confirmation. The user may use the joystick 11 to manipulate and move the claw inside the machine and press the button 13 for catching an article (prize).

In the present invention, each claw unit in the claw machine 10 is electrically connected to a driver board. The main control board H is electrically coupled to the driver boards of the claw units in a one-to-many manner through multiple transmission core wires. The single main control board H is capable of transmitting electronic signals to the multiple driver boards, so that the cost of the main control board H and the driver boards can be reduced greatly and individual faulty driver boards can be replaced or repaired. The present invention achieves the practical progress of cost reduction and maintenance convenience.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A claw machine having a main control board drive device, comprising:
at least two interconnected claw units, each including a control unit;
a main control board, each of the claw units being electrically connected to a driver board, the main control board being electrically coupled to the driver boards of the claw units in a one-to-many manner through a plurality of transmission core wires so that the main control board is capable of transmitting electronic signals to the driver boards of the claw units.

2. The claw machine as claimed in claim 1, wherein the main control board is electrically coupled to a counting receiving board through a transmission cable, the counting receiving board is electrically coupled to a coin acceptor through another transmission cable, coin data is transmitted to the counting receiver board by means of a coin value of the coin acceptor through the another transmission cable, the counting receiver board transmits counting data to the main control board through the transmission cable, the main control board transmits the counting data to the driver boards of the claw units through the transmission core wires, and the driver boards of the claw units are controlled by the respective control units, so that the counting data is fed back for playing a game in a single-player mode or a multi-player mode.

3. The claw machine as claimed in claim 1, wherein the control unit electrically connected to the driver board of each claw unit includes a joystick, a liquid crystal display, a button, and a speaker.

4. The claw machine as claimed in claim 1, wherein the at least two interconnected claw units includes four interconnected claw units, defined as a first claw unit, a second claw unit, a third claw unit and a fourth claw unit; the first claw unit is electrically coupled to a first driver board, the second claw unit is electrically coupled to a second driver board, the third claw unit is electrically coupled to a third driver board, the fourth claw unit is electrically coupled to a fourth driver board; the first driver board is electrically coupled to a first control unit, the second driver board is electrically coupled to a second control unit, the third driver board is electrically coupled to a third control unit, the fourth driver board is electrically coupled to a fourth control unit, and any one of the claw units is electrically connected to a ground.

5. The claw machine as claimed in claim 4, wherein the main control board is equipped with a cable containing five core wires, defined as a first transmission core wire, a second transmission core wire, a third transmission core wire, a fourth transmission core wire, and a fifth transmission core wire; the first transmission core wire is electrically coupled to the first driver board, the second transmission core wire is electrically coupled to the second driver board, the third transmission core wire is electrically coupled to the third driver board, the fourth transmission core wire is electrically coupled to the fourth driver board, and the fifth transmission core wire is electrically coupled to the ground.
